(19) United States
(12) Patent Application Publication
(10) Pub. No.: US 2026/0269740 A1
(43) Pub. Date: Sep. 10, 2026

(54) FOUR-LEG MATRIX DUAL ACTIVE BRIDGE CONVERTER

(71) Applicant: SEMICONDUCTOR COMPONENTS INDUSTRIES, LLC, Scottsdale, AZ (US)

(72) Inventor: Daniel Leon GOLDMANN, Munich (DE)

(73) Assignee: SEMICONDUCTOR COMPONENTS INDUSTRIES, LLC, Scottsdale, AZ (US)

(21) Appl. No.: 19/535,057

(22) Filed: Feb. 10, 2026

Related U.S. Application Data
(60) Provisional application No. 63/768,659, filed on Mar. 7, 2025.
(60) Provisional application No. 63/768,632, filed on Mar. 7, 2025.
(60) Provisional application No. 63/768,601, filed on Mar. 7, 2025.

(51) Int. Cl. H02M 7/219; H02J 7/04

(52) U.S. Cl. CPC H02M 7/219; H02J 7/04

(57) ABSTRACT

A power converter includes a transformer, an H-bridge coupled between a secondary side of the transformer and a battery, a four-leg matrix bridge coupled between an AC voltage input and a primary side of the transformer, and a control circuit coupled to control switching of the four-leg matrix bridge and the H-bridge. The control circuit is configured to apply a parallel phase switching pattern in response to a single-phase AC voltage at the AC voltage input, and to apply a sequential-phase switching pattern in response to three-phase AC voltage at the AC voltage input. The parallel-phase switching pattern comprises switching the first-phase leg, the second-phase leg, and the third-phase leg of the four-leg matrix bridge in parallel. The sequential-phase switching pattern rotates between switching the first-phase leg and the neutral leg, switching the second-phase leg and the neutral leg, and switching the third-phase leg and the neutral leg.

### PRIORITY

This application claims the benefit of U.S. Provisional Patent Application No. 63/768,601, filed Mar. 7, 2025, U.S. Provisional Patent Application No. 63/768,632, filed Mar. 7, 2025, and U.S. Provisional Patent Application No. 63/768,659, filed Mar. 7, 2025, which are each hereby incorporated by reference herein in their entirety.

### TECHNICAL FIELD

The disclosure relates generally to power electronics, and in particular to a four-leg matrix dual active bridge power converter.

### BACKGROUND

Power electronics may be used to control the conversion and distribution of electric power. For example, switching power converters may be used to create a direct current (“DC”) voltage from an alternating current (“AC”) voltage by switching current through a magnetic element such as transformer. Conversely, inverters may be used to convert a DC voltage to an AC voltage.

Isolated power converters may be used in a broad range of applications, including for example as a battery charger for an electric vehicle. Conventional on-board battery chargers may include an AC-DC stage to rectify a low frequency AC voltage from the power grid to produce a DC voltage across an electrolytic bulk capacitor. An isolated DC-to-DC converter stage may in turn be used to transfer power from the electrolytic bulk capacitor to the battery. For example, a high-frequency inverter may convert the DC voltage at the bulk capacitor into a high-frequency AC signal for transfer from the primary side to the secondary side of an isolation transformer. A high-frequency rectifier stage may in turn be coupled to the secondary side of the transformer to convert the high-frequency AC signal to a DC signal for charging the battery. The transformer may provide galvanic isolation between the grid and the battery for safety purposes. In turn, the use of high-frequency switching across the transformer may allow for higher power density and smaller magnetic components, which may be important factors for on-board chargers.

The inventor of embodiments of the present disclosure has recognized that such conventional on-board battery chargers may require the use of bulky components, such as the electrolytic bulk capacitor, that may increase the cost and the physical space required for the on-board battery charger. Matrix converters have been described in the field as a means for converting the low-frequency AC grid voltage directly to a high-frequency AC signal for transfer across the isolation transformer. Such use of a matrix converter may thus eliminate the need for the aforementioned electrolytic bulk capacitor used to store the intermediate DC voltage. However, the inventor of embodiments of the present disclosure has also recognized that various matrix converter topologies may have significant drawbacks. For example, indirect matrix converter topologies may have limited power capability (for example, less than 1 kW) due to parasitic inductances. Further, soft-switching solid state transformer converters (S4T converters) may suffer from large DC currents and reflected voltages across the transformer due to the operation of the transformer as a flyback device. As another example, known three-phase matrix topologies may involve complex modulation schemes, allowing for only one discontinuous modulation scheme and thereby resulting in large peak currents through the high-frequency transformer.

The inventor of embodiments of the present disclosure has also recognized that manufacturers of on-board battery chargers and/or manufacturers of electric vehicles including on-board battery chargers may benefit from a single design that may operate with both a three-phase AC power supply (utilized in Europe and China for example) and single-phase AC power supply (utilized in the United States for example). The inventor of embodiments of the present disclosure has also recognized that the configuration of conventional matrix-based converters optimized for operating with three-phase power may include inefficiencies if alternatively operated with single-phase power. Likewise, the configuration of conventional matrix-based converters optimized for operating with single-phase power may include inefficiencies if alternatively operated with three-phase power. Embodiments of the present disclosure may address one or more of these challenges.

### SUMMARY

The examples herein enable techniques for controlling the switching operation of a four-leg matrix dual active bridge converter.

According to one example, a power converter includes (i) a transformer, (ii) an H-bridge coupled between a secondary side of the transformer and a battery, (iii) a four-leg matrix bridge coupled between an AC voltage input and a primary side of the transformer, the four-leg matrix bridge including a first-phase leg, a second-phase leg, a third-phase leg, and a neutral leg; and (iv) a control circuit coupled to control switching of the four-leg matrix bridge and the H-bridge, the control circuit configured to, in response to a single-phase AC voltage at the AC voltage input, apply a parallel-phase switching pattern that comprises switching the first-phase leg, the second-phase leg, and the third-phase leg of the four-leg matrix bridge in parallel to each other and in conjunction with the neutral leg, and in response to a three-phase AC voltage at the AC voltage input, apply a sequential-phase switching pattern that rotates between a first-phase switching pattern that comprises switching the first-phase leg and the neutral leg for a first period, a second-phase switching pattern that comprises switching the second-phase leg and the neutral leg for a second period, and a third-phase switching pattern that comprises switching the third-phase leg and the neutral leg for a third period. In some embodiments, the first-phase switching pattern further comprises disabling the second-phase leg and the third-phase leg during the first period, the second-phase switching pattern further comprises disabling the first-phase leg and the third-phase leg during the second period, and the third-phase switching pattern further comprises disabling the first-phase leg and the second-phase leg during the third period. In the same or different embodiments, the first-phase leg, the second-phase leg, and the third-phase leg are configured to have a collective power capability that is within ten-percent of a power capability of the neutral leg. In the same or different embodiments, the first-phase leg is configured as a first bidirectional half-bridge between the AC voltage input and the primary side of the transformer, the second-phase leg is configured as a second bidirectional half-bridge between the AC voltage input and the primary side of the transformer, the third-phase leg is configured as a third bidirectional half-bridge between the AC voltage input and the primary side of the transformer, and the neutral leg is configured as a fourth bidirectional half-bridge between neutral and the primary side of the transformer. In the same or different embodiments, each of the first-phase leg, the second-phase leg, and the third-phase leg of the four-leg matrix bridge comprises a first bidirectional switch coupled between a first terminal of a primary winding of the transformer and a respective one of a first, a second, and a third AC voltage input, and a second bidirectional switch coupled between a second terminal of the primary winding of the transformer and the respective one of the first, the second, and the third AC voltage input. In the same or different embodiments, the neutral leg comprises a first bidirectional switch coupled between neutral and the first terminal of the primary winding of the transformer, and a second bidirectional switch coupled between neutral and the second terminal of the primary winding of the transformer. In the same or different embodiments, the H-bridge comprises a first switch coupled between a first terminal of a secondary winding of the transformer and a first terminal of the battery, a second switch coupled between the first terminal of the secondary winding of the transformer and a second terminal of the battery, a third switch coupled between a second terminal of the secondary winding of the transformer and the first terminal of the battery, and a fourth switch coupled between the second terminal of the secondary winding of the transformer and the second terminal of the battery. In the same or different embodiments, the control circuit is configured to control switching of the four-leg matrix bridge and the H-bridge to regulate a flow of power from the AC voltage input to the battery. In the same or different embodiments, the control circuit is configured to control switching of the four-leg matrix bridge and the H-bridge to regulate a flow of power from the battery to the AC voltage input. In the same or different embodiments, the control circuit is configured to select one of plurality of modulation schemes to apply with the parallel-phase switching pattern over a time period based at least in part on a voltage level of the single-phase AC voltage during the time period. In the same or different embodiments, the control circuit is configured to select a respective modulation scheme from among a plurality of modulation schemes for each of the first-phase switching pattern, the second-phase switching pattern, and the third-phase switching pattern, based at least in part on respective voltage levels of a first phase voltage, a second phase voltage, and a third phase voltage at the AC voltage input. In the same or different embodiments, the plurality of modulation schemes includes a triangular modulation scheme, a trapezoidal modulation scheme, an extended phase shift modulation scheme, and a single phase shift modulation scheme.

According to another embodiment, a four-leg matrix dual active bridge power converter includes (i) a transformer, (ii) an H-bridge coupled between a secondary side of the transformer and a battery, (iii) a four-leg matrix bridge including a first-phase leg, a second-phase leg, a third-phase leg, and a neutral leg respectively coupled between a primary side of the transformer and a respective one of a first-phase input of an AC voltage input, a second-phase input of the AC voltage input, a third-phase input of the AC voltage input, and neutral, and (iv) a control circuit coupled to control switching of the four-leg matrix bridge and the H-bridge, the control circuit configured to detect whether an AC voltage at the AC voltage input is a single-phase AC voltage or a three-phase AC voltage, and in response to detecting the single-phase AC voltage, apply a parallel-phase switching pattern that comprises switching the first-phase leg, the second-phase leg, and the third-phase leg of the four-leg matrix bridge in parallel to each other and in conjunction with switching of the neutral leg, and in response to detecting the three-phase AC voltage, apply a sequential-phase switching pattern that rotates between a first-phase switching pattern that comprises switching the first-phase leg and the neutral leg for a first micro-period, a second-phase switching pattern that comprises switching the second-phase leg and the neutral leg for a second micro-period, and a third-phase switching pattern that comprises switching the third-phase leg and the neutral leg for a third micro-period. In some embodiments, the first-phase switching pattern further comprises disabling the second-phase leg and the third-phase leg during the first period, the second-phase switching pattern further comprises disabling the first-phase leg and the third-phase leg during the second period, and the third-phase switching pattern further comprises disabling the first-phase leg and the second-phase leg during the third period. In the same or different embodiments, the first-phase leg, the second-phase leg, and the third-phase leg are configured to have a collective power capability that is within ten-percent of a power capability of the neutral leg.

Another example provides a method for operating a power converter, wherein the method includes (i) receiving an AC voltage at a first-phase leg, a second-phase leg, and a third-phase leg, of a four-leg matrix bridge coupled between an AC voltage input and a primary side of a transformer, (ii) detecting whether the AC voltage is single-phase or three-phase, (iii) selecting a parallel-phase switching pattern if the AC voltage is single-phase, wherein the parallel-phase switching pattern includes switching the first-phase leg, the second-phase leg, and the third-phase leg of the four-leg matrix bridge in parallel to each other and in conjunction with a neutral leg of the four-leg matrix bridge, (iv) selecting a sequential-phase switching pattern if the AC voltage is three-phase, wherein the sequential-phase switching pattern rotates between a first-phase switching pattern that comprises switching the first-phase leg and the neutral leg for a first micro-period, a second-phase switching pattern that comprises switching the second-phase leg and the neutral leg for a second micro-period, and a third-phase switching pattern that comprises switching the third-phase leg and the neutral leg for a third micro-period, (v) switching the four-leg matrix bridge according to a selected one of the parallel-phase switching pattern and the sequential-phase switching pattern, and (vi) switching an H-bridge that is coupled between a secondary side of the transformer and a battery. In some embodiments, the first-phase switching pattern further comprises disabling the second-phase leg and the third-phase leg during the first micro-period, the second-phase switching pattern further comprises disabling the first-phase leg and the third-phase leg during the second micro-period, and the third-phase switching pattern further comprises disabling the first-phase leg and the second-phase leg during the third micro-period. In the same or different embodiments, the method further comprises selecting one of plurality of modulation schemes to apply with the parallel-phase switching pattern over a time period based at least in part on a single-phase voltage level of the AC voltage during the time period. In the same or different embodiments, the method further comprises selecting a respective modulation scheme from among a plurality of modulation schemes for each of the first-phase switching pattern, the second-phase switching pattern, and the third-phase switching pattern, based at least in part on respective levels of a first phase voltage, a second phase voltage, and a third phase voltage at the AC voltage input. In the same or different embodiments, the plurality of modulation schemes includes a triangular modulation scheme, a trapezoidal modulation scheme, an extended phase shift modulation scheme, and a single phase shift modulation scheme.

### BRIEF DESCRIPTION OF THE DRAWINGS

A more complete understanding of the present embodiments may be acquired by referring to the following description taken in conjunction with the accompanying drawings, in which like reference numbers indicate like features.

FIG. 1A illustrates a schematic diagram of an interface between a three-phase AC supply and a power converter in accordance with embodiments of the present disclosure.

FIG. 1B illustrates a schematic diagram of an interface between a single-phase AC supply and a power converter in accordance with embodiments of the present disclosure.

FIG. 1C illustrates a schematic diagram of a power converter in accordance with embodiments of the present disclosure.

FIG. 2A illustrates operational modes of a power converter in accordance with embodiments of the present disclosure.

FIG. 2B illustrates a simplified schematic diagram of a power converter during a discrete period of operation in accordance with embodiments of the present disclosure.

FIG. 3A illustrates operational modes of a power converter in accordance with embodiments of the present disclosure.

FIG. 3B illustrates a simplified schematic diagram of a power converter during a discrete period of operation in accordance with embodiments of the present disclosure.

FIG. 4 illustrates an example method of operating a power converter in accordance with embodiments of the present disclosure.

### DETAILED DESCRIPTION

Details of one or more embodiments are set forth in the description below and the accompanying drawings. Other features will be apparent from the description, drawings, and from the claims. The embodiments disclosed should not be interpreted, or otherwise used, as limiting the scope of the disclosure, including the claims. In addition, one skilled in the art understands that the following description has broad application, and the discussion of any embodiment is meant to be exemplary of that embodiment, and not intended to intimate that the scope of the disclosure, including the claims, is limited to that embodiment.

Various terms are used to refer to particular system components. Different companies may refer to a component by different names, and this disclosure does not intend to distinguish between components that differ in name but not form and function. In the following discussion and in the claims, the terms “including” and “comprising” are used in an open-ended fashion, and thus should be interpreted to mean “including, but not limited to.” Also, the term “couple” or “coupled” is intended to mean either an indirect or direct connection. Thus, if a first device couples to, or is coupled to, a second device, that connection between the first device and the second device may be through a direct connection or through an indirect connection via other devices and connections. As used herein, the term “and/or” includes any and all combinations of one or more of the associated listed items.

Further, although the terms “first,” “second,” “third,” and so forth may be used herein to describe various elements, these elements should not be limited by these terms. Terms such as “first,” “second,” and “third” may be used merely to distinguish one element from another. For example, a first element could be termed a second element, and, similarly, a second element could be termed a first element, without departing from the scope of the present disclosure. Further, the identification of a “first” element, does not necessarily require the presence of a “second” element.

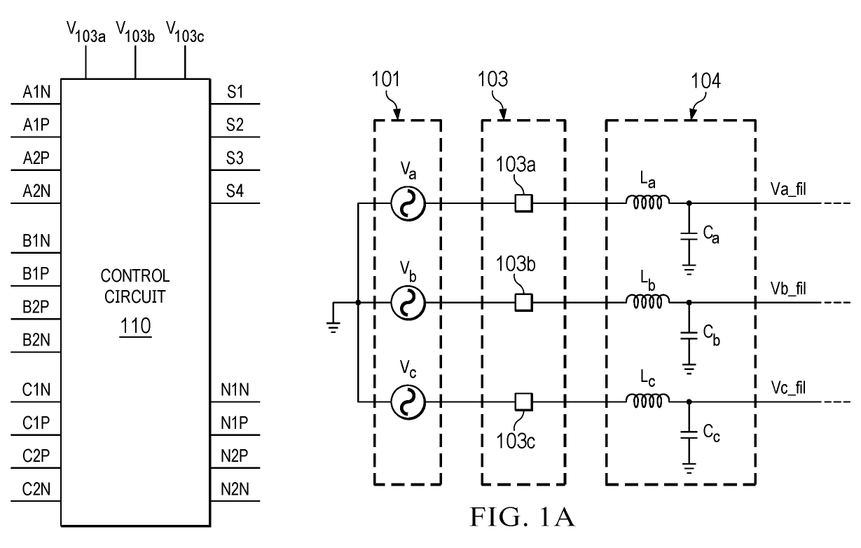

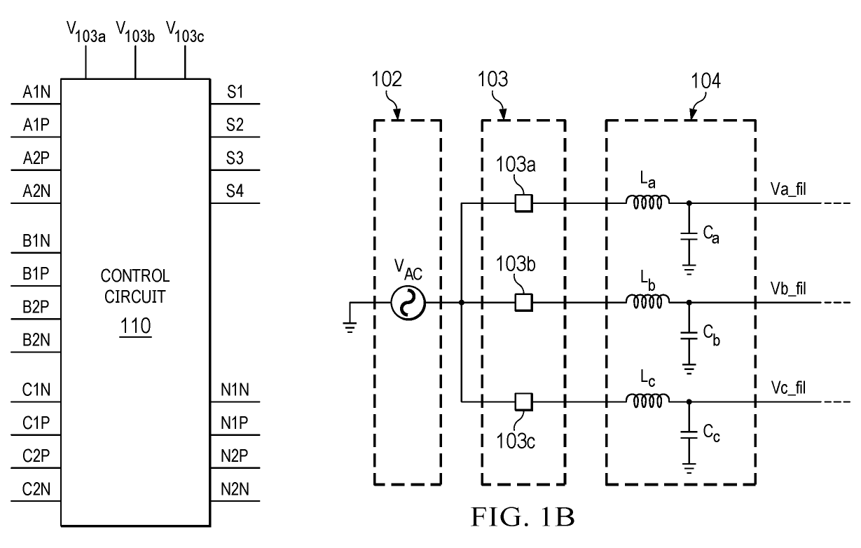

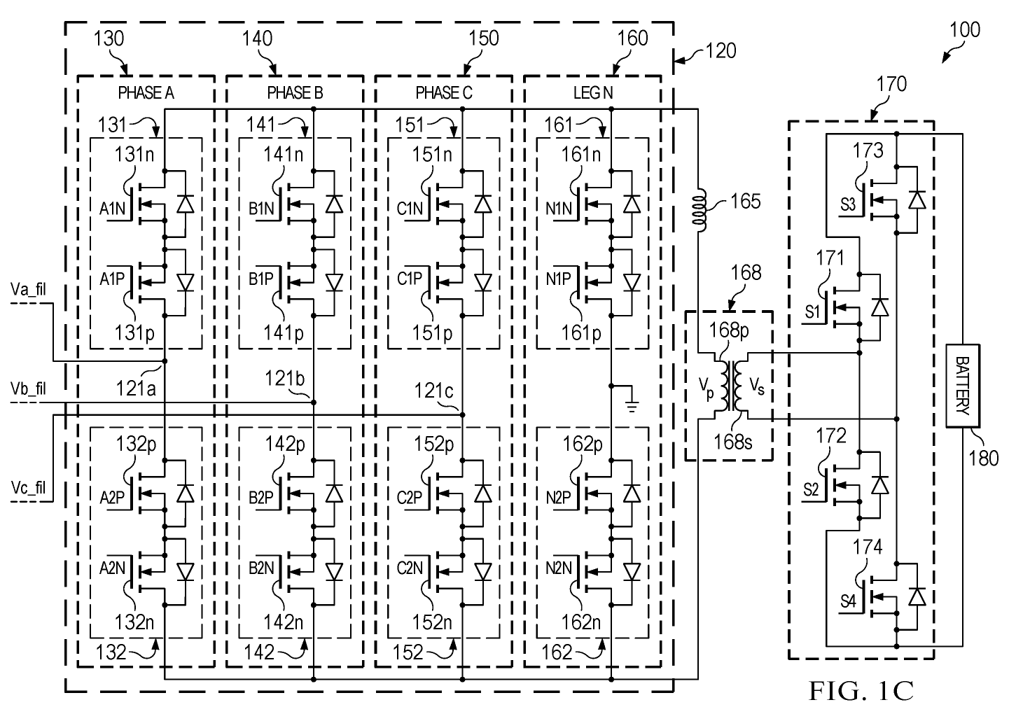

FIGS. 1A-1C collectively illustrate a schematic diagram of a power converter 100 that may optionally be coupled to a single-phase AC supply or a three-phase AC supply in accordance with embodiments of the present disclosure. Specifically, FIG. 1A illustrates an interface between a three-phase AC supply 101 and power converter 100, while FIG. 1B illustrates an interface between a single-phase AC supply 102 and power converter 100. In turn, FIG. 1C illustrates various further components of power converter 100 that may be utilized to convert the three-phase or single-phase AC power into DC power for charging battery 180.

In some embodiments, power converter 100 may include AC voltage input 103, filter 104, and control circuit 110 (shown in both FIGS. 1A and 1B, as well as four-leg matrix bridge 120, inductance 165, transformer 168, and H-bridge 170 (shown in FIG. 1C). As shown in FIG. 1C, four-leg matrix bridge 120 and H-bridge 170 may be coupled on opposing sides of transformer 168 and may be actively controlled by control circuit 110. Thus, for the purposes of the present disclosure, power converter 100 may also be referred to as a four-leg matrix dual active bridge converter. As described in further detail below, control circuit 110 may apply various switching patterns for four-leg matrix bridge 120 and H-bridge 170 depending in part on whether the AC voltage received at AC voltage input 103 is a three-phase AC voltage or a single-phase AC voltage.

As shown in FIG. 1A, AC voltage input 103 may be configured to receive a three-phase AC voltage from three-phase AC supply 101. In some embodiments, three-phase AC supply 101 may represent a three-phase grid supply, for example as commonly available in Europe and/or China. AC voltage input 103 may be configured to receive a first phase voltage Va at a first AC voltage input 103a, to receive a second phase voltage Vb at a second AC voltage input 103b, and to receive a third phase voltage Vc at a third AC voltage input 103c.

As shown in FIG. 1B, AC voltage input 103 may also be configured to alternatively receive a single-phase AC voltage from single-phase AC supply 102. In some embodiments, single-phase AC supply 102 may represent a single-phase grid supply, for example as commonly available in the United States. AC voltage input 103 may be configured to receive a single-phase AC voltage V_{AC} at each of the first AC voltage input 103a, the second AC voltage input 103b, and the third AC voltage input 103c.

As shown in FIGS. 1A and 1B, control circuit 110 may be configured to receive voltage inputs V₁₀₃ₐ, V_{103b}, and V_{103c}, representative of the voltages received at the first AC voltage input 103a, the second AC voltage input 103b, and the third AC voltage input 103c. Accordingly, control circuit 110 may detect whether the AC voltage received at AC voltage input 103 is a three-phase AC voltage or a single-phase AC voltage. And as described in further detail below, control circuit 110 may control the switching of four-leg matrix bridge 120 and H-bridge 170 based at least in part on whether the AC voltage received at AC voltage input 103 is a three-phase AC voltage or a single-phase AC voltage.

Filter 104 may be coupled between AC voltage input 103 and four-leg matrix bridge 120 (shown in FIG. 1C). Filter 104 may be configured to filter the voltages provided by, and the currents drawn from or supplied to, three-phase AC supply 101 or single-phase AC supply 102. For example, three-phase filter may include a first inductor Lₐ and a first capacitor Cₐ configured as an LC filter coupled between first AC voltage input 103a and a first-phase leg 130 of four-leg matrix bridge 120, a second inductor L_{b} and a second capacitor C_{b} configured as an LC filter coupled between second AC voltage input 103b and a second-phase leg 140 of four-leg matrix bridge 120, and a third inductor L_{c} and a third capacitor C_{c} configured as an LC filter coupled between third AC voltage input 103c and a third-phase leg 150 of four-leg matrix bridge 120.

As shown in FIG. 1C, four-leg matrix bridge 120 may be coupled between the AC voltage input 103 and the primary side of transformer 168. Specifically, as shown in FIG. 1C, four-leg matrix bridge 120 may be coupled to receive a filtered AC voltage from AC voltage input 103 via filter 104. For example, four-leg matrix bridge 120 may include first-phase leg 130, second-phase leg 140, and third-phase leg 150. First-phase leg 130 may be coupled at node 121a to first AC voltage input 103a via filter 104 and may thus receive the first phase filtered voltage Va_fil. Second-phase leg 140 may be coupled at node 121b to second AC voltage input 103b via filter 104 and may thus receive the second phase filtered voltage Vb_fil. And third-phase leg 150 may be coupled at node 121c to third AC voltage input 103c via filter 104 and may thus receive the third phase filtered voltage Vc_fil.

As described directly below, each of the first-phase leg 130, second-phase leg 140, and third-phase leg 150 may include a first bidirectional switch coupled between a first terminal of a primary winding 168p of transformer 168 and a respective one of a first, a second, and a third AC voltage input, and may also include a second bidirectional switch coupled between a second terminal of the primary winding 168p of transformer 168 and a respective one of the first, the second, and the third AC voltage input.

First-phase leg 130 (also labeled as PHASE A in FIG. 1C) may be configured as a first bidirectional half-bridge between the AC voltage input 103 and the primary side of transformer 168. For example, first-phase leg 130 may include a first bidirectional switch 131 coupled in series with inductance 165 between a first terminal of primary winding 168p and node 121a, which in turn may be coupled via filter 104 to first AC voltage input 103a. First-phase leg 130 may also include a second bidirectional switch 132 coupled between a second terminal of primary winding 168p and node 121a. In some embodiments, first bidirectional switch 131 may include a first transistor 131n coupled in series with a second transistor 131p, which may be driven at their respective gates by control signals A1N and A1P from control circuit 110. Similarly, second bidirectional switch 132 may include a first transistor 132n coupled in series with a second transistor 132p, which may be driven at their respective gates by control signals A2N and A2P from control circuit 110. As shown in FIG. 1C, the respective first and second transistors of first bidirectional switch 131 and second bidirectional switch 132 may be coupled in series in a back-to-back configuration relative to each other (for example, with their respective sources coupled together) to block any unintended conduction path through the respective body diodes of those first and second transistors of first bidirectional switch 131 and second bidirectional switch 132.

Second-phase leg 140 (also labeled as PHASE B in FIG. 1C) may be configured as a second bidirectional half-bridge between the AC voltage input 103 and the primary side of transformer 168. For example, second-phase leg 140 may include a first bidirectional switch 141 coupled in series with inductance 165 between a first terminal of primary winding 168p and node 121b, which in turn may be coupled via filter 104 to second AC voltage input 103b. Second-phase leg 140 may also include a second bidirectional switch 142 coupled between a second terminal of primary winding 168p and node 121b. In some embodiments, first bidirectional switch 141 may include a first transistor 141n coupled in series with a second transistor 141p, which may be driven at their respective gates by control signals B1N and B1P from control circuit 110. Similarly, second bidirectional switch 142 may include a first transistor 142n coupled in series with a second transistor 142p, which may be driven at their respective gates by control signals B2N and B2P from control circuit 110. As shown in FIG. 1C, the respective first and second transistors of first bidirectional switch 141 and second bidirectional switch 142 may be coupled in series in a back-to-back configuration relative to each other (for example, with their respective sources coupled together) to block any unintended conduction path through the respective body diodes of those first and second transistors of first bidirectional switch 141 and second bidirectional switch 142.

Third-phase leg 150 (also labeled as PHASE C in FIG. 1C) may be configured as a third bidirectional half-bridge between the AC voltage input 103 and the primary side of transformer 168. For example, third-phase leg 150 may include a first bidirectional switch 151 coupled in series with inductance 165 between a first terminal of primary winding 168p and node 121c, which in turn may be coupled via filter 104 to third AC voltage input 103c. Third-phase leg 150 may also include a second bidirectional switch 152 coupled between a second terminal of primary winding 168p and node 121c. In some embodiments, first bidirectional switch 151 may include a first transistor 151ncoupled in series with a second transistor 151p, which may be driven at their respective gates by control signals C1N and C1P from control circuit 110. Similarly, second bidirectional switch 152 may include a first transistor 152n coupled in series with a second transistor 152p, which may be driven at their respective gates by control signals C2N and C2P from control circuit 110. As shown in FIG. 1C, the respective first and second transistors of first bidirectional switch 151 and second bidirectional switch 152 may be coupled in series in a back-to-back configuration relative to each other (for example, with their respective sources coupled together) to block any unintended conduction path through the respective body diodes of those first and second transistors of first bidirectional switch 151 and second bidirectional switch 152.

Neutral leg 160 (also labeled as LEG N in FIG. 1C) may include a first bidirectional switch 161 coupled in series with inductance 165 between a first terminal of primary winding 168p and neutral. Neutral leg 160 may also include a second bidirectional switch 162 coupled between a second terminal of primary winding 168p and neutral. In some embodiments, first bidirectional switch 161 may include a first transistor 161n coupled in series with a second transistor 161p, which may be driven at their respective gates by control signals N1N and N1P from control circuit 110. Similarly, second bidirectional switch 162 may include a first transistor 162n coupled in series with a second transistor 162p, which may be driven at their respective gates by control signals N2N and N2P from control circuit 110. As shown in FIG. 1C, the respective first and second transistors of first bidirectional switch 161 and second bidirectional switch 162 may be coupled in series in a back-to-back configuration relative to each other (for example, with their respective sources coupled together) to block any unintended conduction path through the respective body diodes of those first and second transistors of first bidirectional switch 161 and second bidirectional switch 162.

H-bridge 170 may be coupled between a secondary side of transformer 168 and battery 180. For example, H-bridge 170 may include first switch 171, second switch 172, third switch 173, and fourth switch 174. First switch 171 may be coupled between a first terminal of a secondary winding 168s of transformer 168 and a first terminal of battery 180. Second switch 172 may be coupled between the first terminal of secondary winding 168s of transformer 168 and a second terminal of battery 180. Third switch 173 may be coupled between a second terminal of secondary winding 168s of transformer 168 and the first terminal of battery 180. And fourth switch 174 may be coupled between the second terminal of secondary winding 168s of transformer 168 and the second terminal of battery 180. As shown in FIG. 1C, first switch 171, second switch 172, third switch 173, and fourth switch 174 may be coupled to be driven at their respective gates by respective control signals S1, S2, S3, and S4 from control circuit 110.

In some embodiments, such as shown in FIG. 1C, the various switches that form four-leg matrix bridge 120 and H-bridge 170 may be implemented with for example, n-channel metal-oxide semiconductor field effect transistors (“n-channel MOSFETs” or “NMOS transistors”). In other embodiments, the various switches that form four-leg matrix bridge 120 and H-bridge 170 may be implemented with integrated-gate bi-polar transistors (“IGBTs”), or any other type of transistor suitable to handle the high voltages and currents of the application in which power converter 100 is implemented. In some embodiments, the various switches that form four-leg matrix bridge 120 and H-bridge 170 may be implemented with silicon carbide transistors, such as silicon carbide NMOS transistors or silicon carbide IGBTs. The various switches that form four-leg matrix bridge 120 and H-bridge 170 may also be formed by silicon transistors, or transistors formed on any other type of semiconductor substrate suitable to handle the high currents and high voltages of the application in which power converter 100 is implemented.

Control circuit 110 may be coupled to control switching of four-leg matrix bridge 120 and H-bridge 170. As shown in FIGS. 1A-1C, control circuit 110 may output various control signals to control the switching on and off of the various transistors that form four-leg matrix bridge 120 and H-bridge 170. Specifically, control circuit 110 may be configured to control switching of four-leg matrix bridge 120 and H-bridge 170 to regulate a flow of power from AC voltage input 103 to the battery 180 that is coupled to H-bridge 170. For example, four-leg matrix bridge 120 may be controlled to convert a low-frequency AC input into a high-frequency AC signal that is transmitted across transformer 168 (from the primary side to the secondary side) and rectified by the controlled switching of H-bridge 170 to provide DC power to charge battery 180.

In some embodiments, power converter 100 may be configured as a bidirectional power converter. Accordingly, control circuit 110 may also be configured to control switching of four-leg matrix bridge 120 and H-bridge 170 to regulate a flow of power from battery 180 to AC voltage input 103. During such operation, control circuit 110 may control the switching of H-bridge 170 to convert the DC voltage across battery 180 into a high-frequency AC signal that is transmitted across transformer 168 (from the secondary side to the primary side). During such operation, control circuit 110 may also control the switching of four-leg matrix bridge 120 to convert the high-frequency AC signal from transformer 168 into a low-frequency AC signal that may be placed back on the grid via AC voltage input 103.

As described above, control circuit 110 may be configured to detect whether the AC voltage at AC voltage input 103 is a single-phase AC voltage or a three-phase AC voltage. For example, as shown in FIGS. 1A and 1B, control circuit 110 may be configured to receive voltage inputs V₁₀₃ₐ, V_{103b}, V_{103c} representative of the voltages received at the first AC voltage input 103a, the second AC voltage input 103b, and the third AC voltage input 103c. Thus, in some embodiments, control circuit may assess the relative phases of V₁₀₃ₐ, V_{103b}, V_{103c} to detect whether the AC voltage at AC voltage input 103 is a single-phase AC voltage or a three-phase AC voltage. In other embodiments, control circuit 110 may utilize other means to detect whether the AC voltage at AC voltage input 103 is a single-phase AC voltage or a three-phase AC voltage. For example, control circuit 110 may include an additional input configured to receive a control signal (for example, from a user or from a plug by which the single-phase or three-phase supply is physically coupled to AC voltage input 103) indicating whether the AC voltage at AC voltage input 103 is a single-phase AC voltage or a three-phase AC voltage. And as described below, control circuit 110 may control the switching of four-leg matrix bridge 120 and H-bridge 170 based at least in part on whether the AC voltage received at AC voltage input 103 is a three-phase AC voltage or a single-phase AC voltage.

In some embodiments, control circuit 110 may apply different switching patterns to four-leg matrix bridge 120 (and H-bridge 170) depending on whether the AC voltage received at AC voltage input 103 is single-phase or three-phase. For example, in response to a single-phase AC voltage at AC voltage input 103, control circuit 110 may apply a parallel-phase switching pattern that comprises switching first-phase leg 130, second-phase leg 140, and third-phase leg 150 of four-leg matrix bridge 120 in parallel to each other and in conjunction with neutral leg 160. And in response to a three-phase AC voltage at AC voltage input 103, control circuit 110 may apply a sequential-phase switching pattern that sequentially rotates between (i) a first-phase switching pattern, (ii) a second-phase switching pattern, and (iii) a third-phase switching pattern. The first-phase switching pattern may comprise switching first-phase leg 130 and neutral leg 160 for a first period while disabling second-phase leg 140 and the third-phase leg 150 during the first period. The second-phase switching pattern may comprise switching second-phase leg 140 and neutral leg 160 for a second period while disabling first-phase leg 130 and the third-phase leg 150 during the second period. The third-phase switching pattern may comprise switching third-phase leg 150 and neutral leg 160 for a third period while disabling first-phase leg 130 and the second-phase leg 140 during the third period.

In some embodiments, first-phase leg 130, second-phase leg 140, and third-phase leg 150 may be configured to have a collective power capability that is approximately equal to a power capability of neutral leg 160. For example, first-phase leg 130, second-phase leg 140, and third-phase leg 150 may be configured to have a collective power capability that is within, for example, five-percent or ten-percent of a power capability of neutral leg 160 (for example, in a range from 95 to 105 percent, or in a range from 90 to 110 percent, of a power capability of neutral leg 160). As described above, in response to a single-phase AC voltage at AC voltage input 103, control circuit 110 may apply a parallel-phase switching pattern that comprises switching first-phase leg 130, second-phase leg 140, and third-phase leg 150 of four-leg matrix bridge 120 in parallel to each other and in conjunction with neutral leg 160. And in response to a three-phase AC voltage at AC voltage input 103, control circuit 110 may apply a sequential-phase switching pattern that sequentially rotates between (i) a first-phase switching pattern that switches first-phase leg 130 and neutral leg 160, (ii) a second-phase switching pattern that switches second-phase leg 140 and neutral leg 160, and (iii) a third-phase switching pattern that switches third-phase leg 150 and neutral leg 160. Thus, under either three-phase or single-phase AC input conditions, the current-carrying capability and the heat transfer capability of the various components of four-leg matrix bridge 120 may be optimized by configuring each of the first-phase leg 130, second-phase leg 140, and third-phase leg 150 to have approximately one-third of the power capability of neutral leg 160.

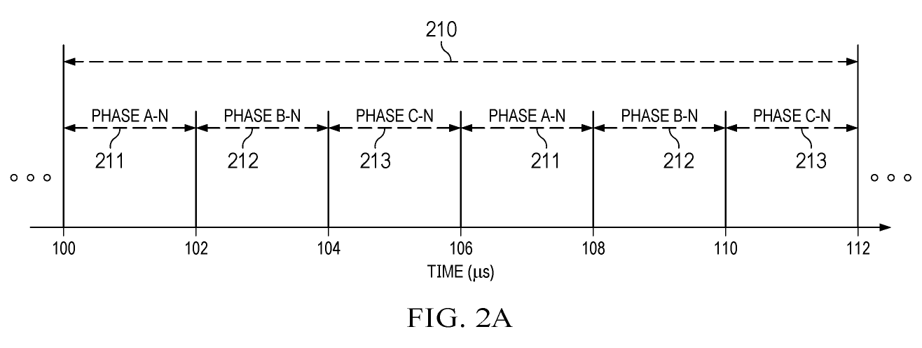

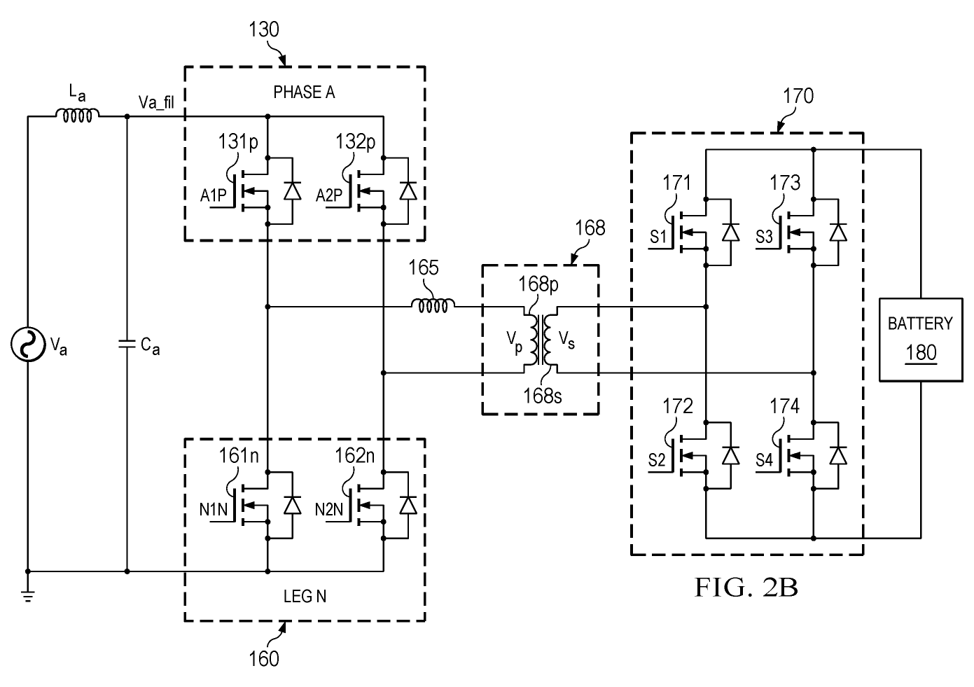

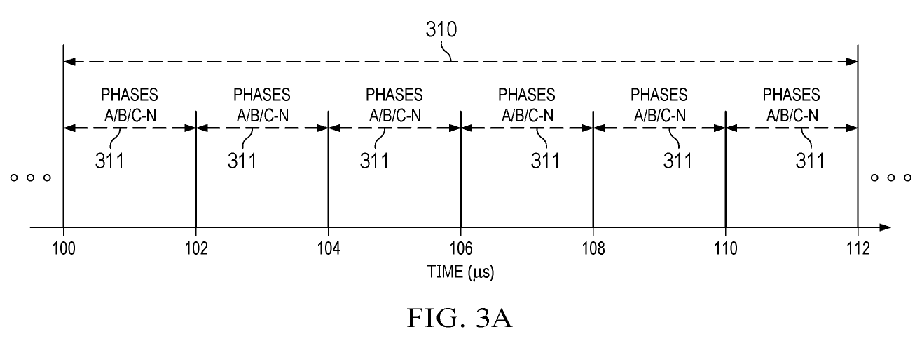

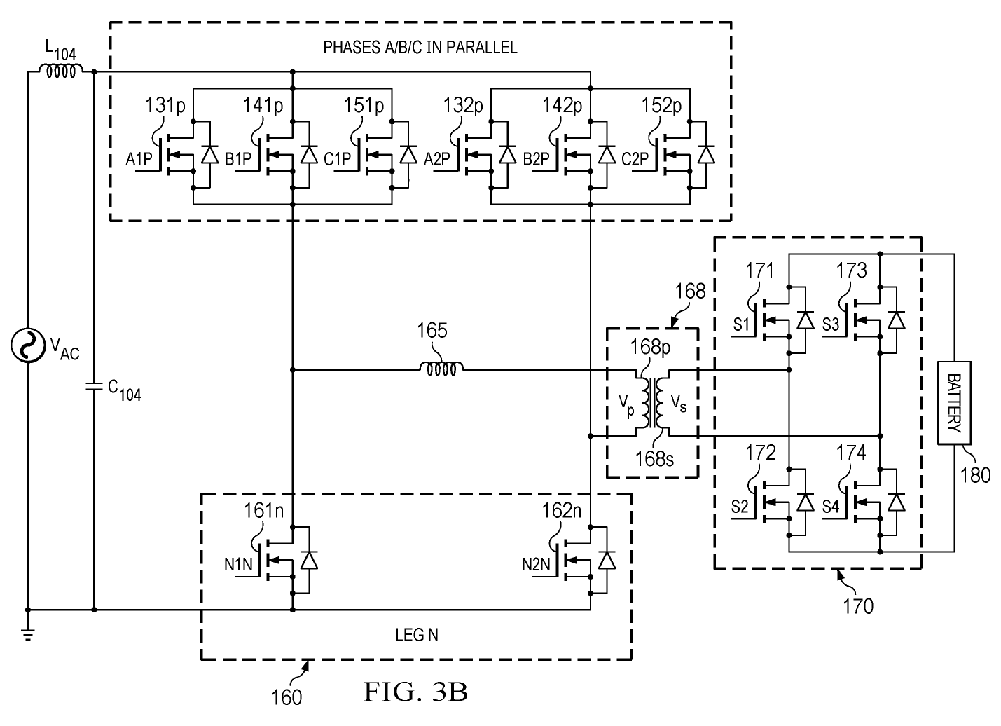

The operation of power converter 100 under conditions with a three-phase AC input is described in further detail below with reference to FIGS. 2A and 2B. Further, the operation of power converter 100 under conditions with a single-phase AC input is described in further detail with reference to FIGS. 3A and 3B.

FIG. 2A illustrates operational modes of power converter 100 in accordance with embodiments of the present disclosure. Specifically, FIG. 2A illustrates operating modes of power converter 100 in response to a three-phase AC voltage being detected at AC voltage input 103.

The inventor of embodiments of the present disclosure has recognized that the control scheme for controlling the switching of four-leg matrix bridge 120 and H-bridge 170 may be significantly simplified by time-division multiplexing the switching control provided by control circuit 110 under conditions where a three-phase AC voltage is detected at AC voltage input 103. For example, control circuit 110 may be configured to sequentially rotate between (i) a first-phase switching pattern (labeled as PHASE A-N in FIG. 2A) that includes switching first-phase leg 130 and neutral leg for a first period 211, (ii) a second-phase switching pattern (labeled as PHASE B-N in FIG. 2A) that includes switching second-phase leg 140 and neutral leg 160 for a second period 212, and (iii) a third-phase switching pattern (labeled as PHASE C-N in FIG. 2A) that includes switching third-phase leg 150 and neutral leg 160 for a third period 213. As shown in FIG. 2A, first period 211, second period 212, and third period 213 may be on the micro-second scale, for example at 2 µs each. In other embodiments, each of first period 211, second period 212, and third period 213 may be 4 µs, 8 µs, 12 µs or more. Further, first period 211, second period 212, and third period 213 may, in some embodiments, be repeated one or more times throughout a macro-period 210. And as described in further detail below with reference to FIG. 2B, the respective modulation schemes for first period 211, second period 212, and third period 213 may be adjusted over time based at least in part on the respective voltage levels of a first phase voltage (Va), a second phase voltage (Vb), and a third phase voltage (Vc) of a three-phase AC voltage received at AC voltage input 103.

The three-phase AC voltage provided by three-phase AC supply 101 may have a low frequency of 50 Hz, for example. Given the low frequency, the three phase voltages (Va, Vb, and Vc) at AC voltage input 103 may have only a negligible change over the course of a macro-period (such as macro-period 210 shown in FIG. 2A) and the repeated rotating periods (such as first period 211, second period 212, and third period 213) within any given macro-period. Accordingly, the circuit analysis and control scheme for any given period may be simplified as described below.

FIG. 2B illustrates a simplified schematic diagram of power converter 100 during a discrete period of operation in accordance with embodiments of the present disclosure. Specifically, FIG. 2B illustrates a simplified schematic diagram of power converter 100 during first period 211 (shown in FIG. 2A) under conditions whereby the first phase voltage Va received at first AC voltage input 103a is positive.

When operating in any of the first-phase switching pattern, second-phase switching pattern, and third-phase switching pattern, the circuit analysis and corresponding control scheme may be simplified for that period. For example, during each instance of first period 211 within macro-period 210, control circuit 110 may disable second-phase leg 140 and third-phase leg 150 of four-leg matrix bridge 120 by driving the transistors of second-phase leg 140 and third-phase leg 150 in respective off-states. Moreover, because Va is positive throughout first period 211, first transistor 131n of first bidirectional switch 131 and first transistor 132n of second bidirectional switch 132 within first-phase leg 130 may be held in respective on-states throughout first period 211 to save switching losses as those transistors are not needed to selectively block or pass the positive voltage level of Va during first period 211. Further, because Va is positive throughout first period 211, second transistor 161p of first bidirectional switch 161 and second transistor 162p of second bidirectional switch 162 within neutral leg 160 may be held in respective on-states throughout first period 211 to save switching losses as those transistors are not needed to selectively block or pass the positive voltage level of Va during first period 211.

Under the above described conditions for the first-phase switching pattern employed during first period 211, the schematic diagram of power converter 100 may be simplified as shown in FIG. 2B. For example, the second transistors 131p and 132p of first-phase leg 130 (also labeled as PHASE A), combined with first transistors 161n and 162n of neutral leg 160 (also labeled as LEG N), may form a simple H-bridge for applying the differential of the first phase voltage Va and neutral across the primary winding 168p of transformer 168 (and inductance 165). Although FIG. 2B illustrates a simplified schematic specific to the first-phase switching pattern employed during first period 211, it is appreciated that the second-phase switching pattern (employing second-phase leg 140 and neutral leg 160 while disabling first-phase leg 130 and third-phase leg 150) and the third-phase switching pattern (employing third-phase leg 150 and neutral leg 160 while disabling first-phase leg 130 and second-phase leg 140) would result in simplified H-bridge configurations, similar to that shown in FIG. 2B, for likewise applying the differential of Vb and neutral or the differential of Vc and neutral across the primary side of transformer 168.

As is appreciated in the art, the modulation schemes for such an H-bridge configuration at the primary side of a transformer in a dual active bridge converter may be less complex and more robust than modulation schemes for simultaneous three-phase operation of a matrix bridge. Thus, the operation of four-leg matrix bridge 120 during any given period (such as first period 211, second period 212, or third period 213) may allow control circuit 110 to employ a broader range of modulation schemes for the switching pattern employed during that period. For example, control circuit 110 may apply any of a plurality of modulation schemes, wherein the plurality of modulation schemes includes for example a triangular modulation scheme (such as a triangular buck modulation scheme or a triangular boost modulation scheme), a trapezoidal modulation scheme, an extended phase shift modulation scheme, or a single phase shift modulation scheme, during a given period, depending on status of the respective phase voltage and the current required by the application.

In some embodiments, the respective modulation schemes employed by the first-phase switching pattern, the second-phase switching pattern, and the third-phase switching pattern during instances of first period 211, second period 212, and third period 213 respectively, may be the same or different from each other over the course of a single macro-period 210. For the purposes of the present disclosure, a “first-phase switching pattern,” a “second-phase switching pattern,” or a “third-phase switching pattern” may refer to which legs of the four-leg matrix bridge may be employed during a given period. The modulation scheme may in turn refer to the control of the on-times and off-times of the various switches within the selected enabled legs of four-leg matrix bridge 120 in conjunction with the control of H-bridge 170, and the resulting shape of the currents that flow between the AC voltage input 103 and battery 180.

In some embodiments, control circuit 110 may be configured to select a respective modulation scheme from among a plurality of modulation schemes for each of the first-phase switching pattern, the second-phase switching pattern, and the third-phase switching pattern based at least in part on respective voltage levels of first phase voltage Va, second phase voltage Vb, and third phase voltage Vc at AC voltage input 103 across a given macro-period and the alternating micro-periods therein. For example, the pulse-widths of the voltages applied across the primary winding and the secondary winding (and the currents induced as a result thereof) for each of first period 211, second period 212, and third period 213, may be controlled based at least in part on the corresponding phase voltages (the corresponding one of Va, Vb, and Vc) for that period. The modulation scheme for each period may thus be optimized for the specific line to neutral voltage for the corresponding phases. Moreover, short breaks may be included between the alternating first-phase switching pattern, second-phase switching pattern, and third-phase switching pattern. This may allow time for a change from one set of active legs to another set of active legs, and may also prevent the accumulation of flux in the transformer core.

By operating the four-leg matrix bridge 120 according to the rotating first-phase switching pattern, second-phase switching pattern, and third-phase switching pattern described herein, power converter 100 may individually set line-to-neutral currents for each of the first, second, and third phases. Accordingly, the transferred current for a given phase need not linearly track the AC voltage for that phase. Thus, the phase currents may be respectively controlled in a manner that is not necessarily sinusoidal and does not necessarily linearly track the corresponding phase voltages Vₐ, V_{b}, and V_{c} during a given macro-period. Nonetheless, the respective averages of the phase currents may be controlled such that, when filtered by filter 104, those currents may have generally sinusoidal shapes that respectively track Va, Vb, and Vc. Filter 104 may have a cut-off frequency lower than a frequency at which control circuit 110 is configured to rotate between the first-phase switching pattern, the second-phase switching pattern, and the third-phase switching pattern. For example, in some embodiments, filter 104 may have a cut-off frequency of, for example 35 kHz. In other embodiments, the cut-off frequency of filter 104 may be any other frequency lower than the frequency at which control circuit 110 rotates between the first-phase switching pattern, the second-phase switching pattern, and the third-phase switching pattern. Accordingly, the respective averages of the phase currents may be controlled such that the filtered phase currents seen at the grid may have generally sinusoidal shapes that respectively track the sinusoidal shapes of Va, Vb, and Vc. Power converter 100 may thus be operated with a high power factor if and where desired by the battery-charger application in which power converter 100 is implemented.

Under certain non-ideal conditions, the phase voltages Va, Vb, and Vc from three-phase AC supply 101 may be unbalanced. As described above, by operating the four-leg matrix bridge 120 according to the rotating first-phase switching pattern, second-phase switching pattern, and third-phase switching pattern described herein, power converter 100 may individually set line-to-neutral currents for each of the first, second, and third phases. As the respective phase voltages vary up and down, the respective modulation schemes for each of the first-phase switching pattern, second-phase switching pattern, and third-phase switching pattern, may change across different macro-periods. Thus, the phase currents may be respectively controlled in a manner that is not necessarily sinusoidal and does not necessarily linearly track the corresponding phase voltages Va, Vb, and Vc during a given macro-period. Nonetheless, as described above, the respective averages of the phase currents may be controlled such that the filtered phase currents seen at AC voltage input 103 are in turn sinusoidal. However, because the underlying phase currents may be individually controlled and thereby decoupled from linearly tracking the line voltage, the underlying phase currents may be controlled such that the filtered phase currents seen at AC voltage input 103 are sinusoidal and balanced even under conditions where the corresponding phase voltages Va, Vb, and Vc are unbalanced.

FIG. 3A illustrates operational modes of power converter 100 in accordance with embodiments of the present disclosure. Specifically, FIG. 3A illustrates operating modes of power converter 100 in response to a single-phase AC voltage detected at AC voltage input 103.

In some embodiments, control circuit 110 may be configured to apply a parallel-phase switching pattern in response to detecting a single-phase AC voltage at AC voltage input 103. The parallel-phase switching pattern may comprise switching first-phase leg 130, second-phase leg 140, and third-phase leg 150, of four-leg matrix bridge 120 in parallel to each other and in conjunction with the neutral leg 160. The single-phase AC voltage (V_{AC}) provided by single-phase AC supply 102 may have a low frequency of 60 Hz, for example. Given the low frequency, V_{AC} may have only a negligible change over the course of a macro-period (such as macro-period 310 shown in FIG. 3A) and the repeated periods (such as repeated instances of period 311) within any given macro-period. Accordingly, the circuit analysis and control scheme for any given period may be simplified as described below.

FIG. 3B illustrates a simplified schematic diagram of power converter 100 during a discrete period of operation in accordance with embodiments of the present disclosure. Specifically, FIG. 3B illustrates a simplified schematic diagram of power converter 100 during period 311 (shown in FIG. 3A) under conditions whereby the V_{AC} is positive.

Because V_{AC} is positive throughout macro-period 310 (and thus during any number of repeated instances of period 311 therein), the respective first transistors 131n, 141n, 151n of the first bidirectional switches 131, 141, and 151, as well as the respective first transistors 132n, 142n, and 152n of the second bidirectional switches 132, 142, and 152 may be held in respective on-states throughout period 311 to save switching losses as those transistors are not needed to selectively block or pass the positive voltage level of V_{AC} during period 311. Further, because V_{AC} is positive throughout period 311, second transistor 161p of first bidirectional switch 161 and second transistor 162p of second bidirectional switch 162 within neutral leg 160 may be held in respective on-states throughout period 311 to save switching losses as those transistors are not needed to selectively block or pass the positive voltage level of V_{AC} during period 311.

Under the above described conditions for the parallel-phase switching pattern during period 311, the schematic diagram of power converter 100 may be simplified as shown in FIG. 3B. For example, second transistor 131p, second transistor 141p, and second transistor 151p of the respective first bidirectional switches of first-phase leg 130, second-phase leg 140, and third-phase leg 150, may be switched in parallel to each other. In other words, control circuit 110 may apply the same or similar signal for control signals A1P, B1P, and C1P to turn second transistor 131p, second transistor 141p, and second transistor 151p on and off together. Further, second transistor 132p, second transistor 142p, and second transistor 152p of the respective second bidirectional switches of first-phase leg 130, second-phase leg 140, and third-phase leg 150, may be switched in parallel to each other. In other words, control circuit 110 may apply the same or similar signal for control signals A2P, B2P, and C2P to turn second transistor 132p, second transistor 142p, and second transistor 152p on and off together.

Accordingly, second transistors 131p, 141p, and 151p, and second transistors 132p, 142p, and 152p, may combine with first transistors 161n and 162n of neutral leg 160 to form a simple H-bridge for applying the differential voltage of V_{AC} to neutral across the primary winding 168p of transformer 168 (and inductance 165). The inductor L₁₀₄and capacitor C₁₀₄shown in FIG. 3B may represent the collective inductances (Lₐ, L_{b}, and L_{c}) and the collective capacitances (Cₐ, C_{b}, and C_{c}) of filter 104 shown in FIG. 1A and FIG. 1B.

As is appreciated in the art, the modulation schemes for such an H-bridge configuration at the primary side of a transformer in a dual active bridge converter may be less complex and more robust than modulation schemes for simultaneous three-phase operation of a matrix bridge. Thus, the operation of four-leg matrix bridge 120 during period 311 may allow control circuit 110 to employ a broad range of modulation schemes for the parallel-phase switching pattern employed during that period. For example, control circuit 110 may apply any of a plurality of modulation schemes, wherein the plurality of modulation schemes includes for example a triangular modulation scheme (such as a triangular buck modulation scheme or a triangular boost modulation scheme), a trapezoidal modulation scheme, an extended phase shift modulation scheme, or a single phase shift modulation scheme, during a given period, depending on status of the respective phase voltage and the current required by the application. For the purposes of the present disclosure, a “parallel-phase switching pattern” may refer to the legs of the four-leg matrix bridge that may be employed in parallel during a given period. The modulation scheme may in turn refer to the control of the on-times and off-times of the various switches within those parallel legs of four-leg matrix bridge 120 in conjunction with the control of H-bridge 170, and the resulting shape of the currents that flow between the AC voltage input 103 and battery 180.

In some embodiments, control circuit 110 may be configured to select one of a plurality of modulation schemes to apply with the parallel-phase switching pattern over a time period based at least in part on the voltage level of the single-phase AC voltage (V_{AC}) during the time period. Given the relatively low frequency of V_{AC} (for example, 60 Hz) compared to the time scale of macro-period 310, V_{AC} may have only a negligible change over the course of macro-period 310 and the repeated instances of period 311 therein. Control circuit 110 may thus be configured to select one of a plurality of modulation schemes based on a voltage level of the single-phase AC voltage during a macro-period 310. For example, the pulse-widths of the voltages applied across the primary winding and the secondary winding (and the currents induced as a result thereof) for each instance of period 311 within macro-period 310 may be controlled based on the voltage level of V_{AC} for that period. The modulation scheme for each period may thus be optimized for the specific line to neutral voltage during that period. As V_{AC} changes during subsequent macro-periods, control circuit 110 may thus change the modulation scheme for any number of instances of period 311 within that subsequent macro-period based at least in part on the present voltage level of V_{AC}.

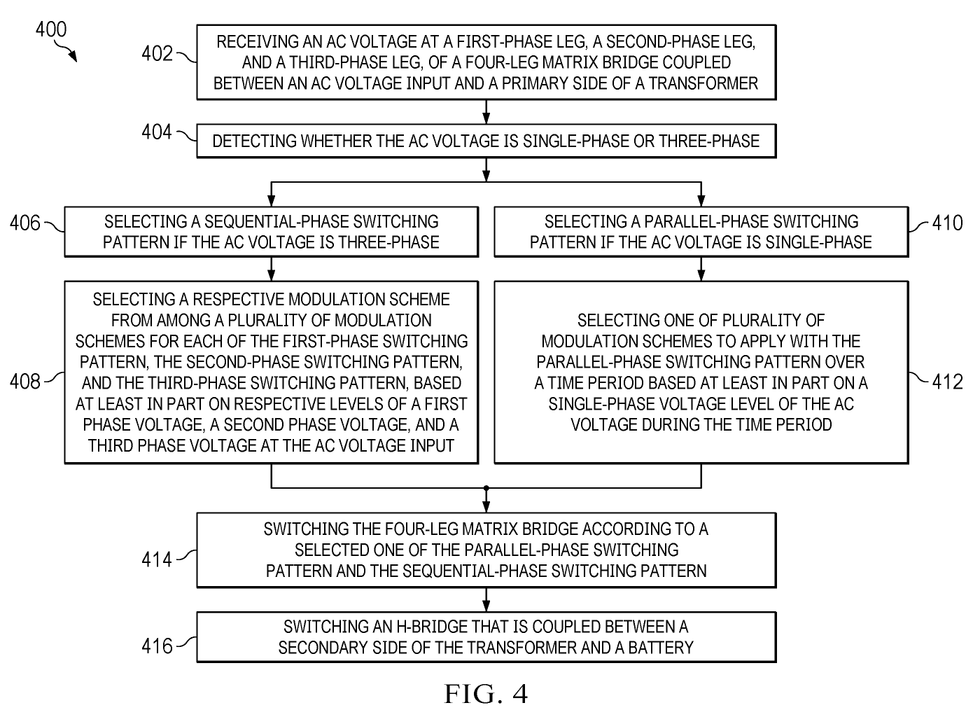

FIG. 4 illustrates an example method 400 of operating a power converter in accordance with embodiments of the present disclosure. Method 400 may be performed by any suitable mechanism, such as control circuit 110 and/or power converter 100, and/or any suitable combination of the components included therein. Method 400 may be performed with fewer or more steps than shown in FIG. 4. Moreover, steps of method 400 may be omitted, repeated, performed in parallel, performed in a different order than shown in FIG. 4, or performed recursively. One or more steps of method 400, although shown in an order, may be performed at the same time or in a re-ordered manner.

Step 402 may include receiving an AC voltage at a first-phase leg, a second-phase leg, and a third-phase leg, of a four-leg matrix bridge coupled between an AC voltage input and a primary side of a transformer. For example, as described above with reference to FIGS. 1A-1C, four-leg matrix bridge 120 may be coupled between the AC voltage input 103 and the primary side of transformer 168. Four-leg matrix bridge 120 may be coupled to receive a filtered AC voltage from AC voltage input 103 via filter 104. For example, four-leg matrix bridge 120 may include first-phase leg 130, second-phase leg 140, and third-phase leg 150. First-phase leg 130 may be coupled at node 121a to first AC voltage input 103a via filter 104 and may thus receive the first phase filtered voltage Va_fil. Second-phase leg 140 may be coupled at node 121b to second AC voltage input 103b via filter 104 and may thus receive the second phase filtered voltage Vb_fil. And third-phase leg 150 may be coupled at node 121c to third AC voltage input 103c via filter 104 and may thus receive the third phase filtered voltage Vc_fil

Step 404 may include detecting whether the AC voltage is single-phase or three-phase. For example, as described above with reference to FIGS. 1A-1C, control circuit 110 may be configured to receive voltage inputs V₁₀₃ₐ, V_{103b}, V_{103c}representative of the voltages received at the first AC voltage input 103a, the second AC voltage input 103b, and the third AC voltage input 103c. Accordingly, control circuit 110 may detect whether the AC voltage received at AC voltage input 103 is a three-phase AC voltage or a single-phase AC voltage.

Method 400 may proceed to either steps 406 and 408 or steps 410 and 412 depending on whether the AC voltage is a three-phase AC voltage or a single-phase AC voltage.

Step 406 may include selecting a sequential-phase switching pattern if the AC voltage is three-phase. Step 408 may include selecting a respective modulation scheme from among a plurality of modulation schemes for each of the first-phase switching pattern, the second-phase switching pattern, and the third-phase switching pattern, based at least in part on respective levels of a first phase voltage, a second phase voltage, and a third phase voltage at the AC voltage input. For example, as described above, control circuit 110 may, in response to a three-phase AC voltage at AC voltage input 103, select and apply a sequential-phase switching pattern that sequentially rotates between (i) a first-phase switching pattern, (ii) a second-phase switching pattern, and (iii) a third-phase switching pattern. The first-phase switching pattern may comprise switching first-phase leg 130 and neutral leg 160 for a first period while disabling second-phase leg 140 and the third-phase leg 150 during the first period. The second-phase switching pattern may comprise switching second-phase leg 140 and neutral leg 160 for a second period while disabling first-phase leg 130 and the third-phase leg 150 during the second period. The third-phase switching pattern may comprise switching third-phase leg 150 and neutral leg 160 for a third period while disabling first-phase leg 130 and the second-phase leg 140 during the third period. Further, as described above with reference to FIGS. 2A-2B, control circuit 110 may be configured to select a respective modulation scheme from among a plurality of modulation schemes for each of the first-phase switching pattern, the second-phase switching pattern, and the third-phase switching pattern based at least in part on respective voltage levels of first phase voltage Va, second phase voltage Vb, and third phase voltage Vc at AC voltage input 103 across a given macro-period and the alternating micro-periods therein. For example, the pulse-widths of the voltages applied across the primary winding and the secondary winding (and the currents induced as a result thereof) for each of first period 211, second period 212, and third period 213, may be controlled based at least in part on the corresponding phase voltages (the corresponding one of Va, Vb, and Vc) for that period.

Step 410 may include selecting a parallel-phase switching pattern if the AC voltage is single-phase. Step 412 may include selecting one of plurality of modulation schemes to apply with the parallel-phase switching pattern over a time period based at least in part on a single-phase voltage level of the AC voltage during the time period. For example, as described above, control circuit 110 may select and apply a parallel-phase switching pattern in response to detecting a single-phase AC voltage at AC voltage input 103. The parallel-phase switching pattern may comprise switching first-phase leg 130, second-phase leg 140, and third-phase leg 150, of four-leg matrix bridge 120 in parallel to each other and in conjunction with the neutral leg 160. Further, as described above with reference to FIGS. 3A-3B, control circuit 110 may be configured to select one of a plurality of modulation schemes to apply with the parallel-phase switching pattern over a time period based at least in part on the voltage level of the single-phase AC voltage (V_{AC}) received at AC voltage input 103 during the time period.

Step 414 may include switching the four-leg matrix bridge according to a selected one of the parallel-phase switching pattern and the sequential-phase switching pattern. Step 416 may include switching an H-bridge that is coupled between a secondary side of the transformer and a battery. For example, as described above with reference to FIGS. 1A-1C, control circuit 110 may output various control signals to control the switching of the transistors that comprise four-leg matrix bridge 120 and H-bridge 170 according to the selected switching pattern (either a sequential-phase switching pattern or a parallel-phase switching pattern) and the selected modulation scheme (for example, a selected one of a triangular modulation scheme, a trapezoidal modulation scheme, an extended phase shift modulation scheme, or a single phase shift modulation scheme).

Although examples have been described above, other modifications and variations may be made from this disclosure without departing from the spirit and scope of these examples. The above descriptions of various embodiments illustrate the principles of the invention. Numerous variations and modifications will become apparent to those skilled in the art based on the above disclosure. The following claims are intended to embrace all such variations and modifications.

1. A power converter comprising:
a transformer;
an H-bridge coupled between a secondary side of the transformer and a battery;
a four-leg matrix bridge coupled between an AC voltage input and a primary side of the transformer, the four-leg matrix bridge including a first-phase leg, a second-phase leg, a third-phase leg, and a neutral leg; and
a control circuit coupled to control switching of the four-leg matrix bridge and the H-bridge, the control circuit configured to:
in response to a single-phase AC voltage at the AC voltage input, apply a parallel-phase switching pattern that comprises switching the first-phase leg, the second-phase leg, and the third-phase leg of the four-leg matrix bridge in parallel to each other and in conjunction with the neutral leg; and
in response to a three-phase AC voltage at the AC voltage input, apply a sequential-phase switching pattern that rotates between:
a first-phase switching pattern that comprises switching the first-phase leg and the neutral leg for a first period;
a second-phase switching pattern that comprises switching the second-phase leg and the neutral leg for a second period; and
a third-phase switching pattern that comprises switching the third-phase leg and the neutral leg for a third period.

2. The power converter of claim 1, wherein:
the first-phase switching pattern further comprises disabling the second-phase leg and the third-phase leg during the first period;
the second-phase switching pattern further comprises disabling the first-phase leg and the third-phase leg during the second period; and
the third-phase switching pattern further comprises disabling the first-phase leg and the second-phase leg during the third period.

3. The power converter of claim 1, wherein the first-phase leg, the second-phase leg, and the third-phase leg are configured to have a collective power capability that is within ten-percent of a power capability of the neutral leg.

4. The power converter of claim 1, wherein:
the first-phase leg is configured as a first bidirectional half-bridge between the AC voltage input and the primary side of the transformer;
the second-phase leg is configured as a second bidirectional half-bridge between the AC voltage input and the primary side of the transformer;
the third-phase leg is configured as a third bidirectional half-bridge between the AC voltage input and the primary side of the transformer; and
the neutral leg is configured as a fourth bidirectional half-bridge between neutral and the primary side of the transformer.

5. The power converter of claim 4, wherein:
each of the first-phase leg, the second-phase leg, and the third-phase leg of the four-leg matrix bridge comprises a first bidirectional switch coupled between a first terminal of a primary winding of the transformer and a respective one of a first, a second, and a third AC voltage input, and a second bidirectional switch coupled between a second terminal of the primary winding of the transformer and a respective one of the first, the second, and the third AC voltage input; and
the neutral leg comprises a first bidirectional switch coupled between neutral and the first terminal of the primary winding of the transformer, and a second bidirectional switch coupled between neutral and the second terminal of the primary winding of the transformer.

6. The power converter of claim 1, wherein the H-bridge comprises:
a first switch coupled between a first terminal of a secondary winding of the transformer and a first terminal of the battery;
a second switch coupled between the first terminal of the secondary winding of the transformer and a second terminal of the battery;
a third switch coupled between a second terminal of the secondary winding of the transformer and the first terminal of the battery; and
a fourth switch coupled between the second terminal of the secondary winding of the transformer and the second terminal of the battery.

7. The power converter of claim 1, wherein the control circuit is configured to control switching of the four-leg matrix bridge and the H-bridge to regulate a flow of power from the AC voltage input to the battery.

8. The power converter of claim 1, wherein the control circuit is configured to control switching of the four-leg matrix bridge and the H-bridge to regulate a flow of power from the battery to the AC voltage input.

9. The power converter of claim 1, the control circuit is configured to select one of plurality of modulation schemes to apply with the parallel-phase switching pattern over a time period based at least in part on a voltage level of the single-phase AC voltage during the time period.

10. The power converter of claim 9, wherein the plurality of modulation schemes includes a triangular modulation scheme, a trapezoidal modulation scheme, an extended phase shift modulation scheme, and a single phase shift modulation scheme.

11. The power converter of claim 1, the control circuit is configured to select a respective modulation scheme from among a plurality of modulation schemes for each of the first-phase switching pattern, the second-phase switching pattern, and the third-phase switching pattern, based at least in part on respective voltage levels of a first phase voltage, a second phase voltage, and a third phase voltage at the AC voltage input.

12. The power converter of claim 11, wherein the plurality of modulation schemes includes a triangular modulation scheme, a trapezoidal modulation scheme, an extended phase shift modulation scheme, and a single phase shift modulation scheme.

13. A four-leg matrix dual active bridge power converter, comprising:
a transformer;
an H-bridge coupled between a secondary side of the transformer and a battery;
a four-leg matrix bridge including a first-phase leg, a second-phase leg, a third-phase leg, and a neutral leg respectively coupled between a primary side of the transformer and a respective one of a first-phase input of an AC voltage input, a second-phase input of the AC voltage input, a third-phase input of the AC voltage input, and neutral;
a control circuit coupled to control switching of the four-leg matrix bridge and the H-bridge, the control circuit configured to:
detect whether an AC voltage at the AC voltage input is a single-phase AC voltage or a three-phase AC voltage;
in response to detecting the single-phase AC voltage, apply a parallel-phase switching pattern that comprises switching the first-phase leg, the second-phase leg, and the third-phase leg of the four-leg matrix bridge in parallel to each other and in conjunction with switching of the neutral leg; and
in response to detecting the three-phase AC voltage, apply a sequential-phase switching pattern that rotates between:
a first-phase switching pattern that comprises switching the first-phase leg and the neutral leg for a first micro-period;
a second-phase switching pattern that comprises switching the second-phase leg and the neutral leg for a second micro-period; and
a third-phase switching pattern that comprises switching the third-phase leg and the neutral leg for a third micro-period.

14. The four-leg matrix dual active bridge power converter of claim 13, wherein the first-phase leg, the second-phase leg, and the third-phase leg are configured to have a collective power capability that is within ten-percent of a power capability of the neutral leg.

15. A method of operating a four-leg matrix dual active bridge power converter, comprising:
receiving an AC voltage at a first-phase leg, a second-phase leg, and a third-phase leg, of a four-leg matrix bridge coupled between an AC voltage input and a primary side of a transformer;
detecting whether the AC voltage is single-phase or three-phase;
selecting a parallel-phase switching pattern if the AC voltage is single-phase, wherein the parallel-phase switching pattern includes switching the first-phase leg, the second-phase leg, and the third-phase leg of the four-leg matrix bridge in parallel to each other and in conjunction with a neutral leg of the four-leg matrix bridge;
selecting a sequential-phase switching pattern if the AC voltage is three-phase, wherein the sequential-phase switching pattern rotates between:
a first-phase switching pattern that comprises switching the first-phase leg and the neutral leg for a first micro-period;
a second-phase switching pattern that comprises switching the second-phase leg and the neutral leg for a second micro-period; and
a third-phase switching pattern that comprises switching the third-phase leg and the neutral leg for a third micro-period;
switching the four-leg matrix bridge according to a selected one of the parallel-phase switching pattern and the sequential-phase switching pattern; and
switching an H-bridge that is coupled between a secondary side of the transformer and a battery.

16. The method of claim 15, wherein:
the first-phase switching pattern further comprises disabling the second-phase leg and the third-phase leg during the first micro-period;
the second-phase switching pattern further comprises disabling the first-phase leg and the third-phase leg during the second micro-period; and
the third-phase switching pattern further comprises disabling the first-phase leg and the second-phase leg during the third micro-period.

17. The method of claim 15, further comprising selecting one of plurality of modulation schemes to apply with the parallel-phase switching pattern over a time period based at least in part on a single-phase voltage level of the AC voltage during the time period.

18. The method of claim 17, wherein the plurality of modulation schemes includes a triangular modulation scheme, a trapezoidal modulation scheme, an extended phase shift modulation scheme, and a single phase shift modulation scheme.

19. The method of claim 15, further comprising selecting a respective modulation scheme from among a plurality of modulation schemes for each of the first-phase switching pattern, the second-phase switching pattern, and the third-phase switching pattern, based at least in part on respective levels of a first phase voltage, a second phase voltage, and a third phase voltage at the AC voltage input.

20. The method of claim 19, wherein the plurality of modulation schemes includes a triangular modulation scheme, a trapezoidal modulation scheme, an extended phase shift modulation scheme, and a single phase shift modulation scheme.
